(19) United States
(12) Patent Application Publication
(10) Pub. No.: US 2021/0246928 A1
(43) Pub. Date: Aug. 12, 2021

(54) FASTENER HAVING IMPROVED WOBBLE CONTROL, FASTENING SYSTEM INCLUDING THE SAME, AND METHOD OF FORMING THE SAME

(71) Applicants: Carl Chasse, Stafford Springs, CT (US); SHEH FUNG SCREWS CO., LTD, Kaohsiung (TW)

(72) Inventor: Carl Chasse, Stafford Springs, CT (US)

(21) Appl. No.: 17/166,034

(22) Filed: Feb. 3, 2021

Related U.S. Application Data
(60) Provisional application No. 62/972,734, filed on Feb. 11, 2020.

(51) Int. Cl. F16B 23/00

(52) U.S. Cl. CPC F16B 23/003

(57) ABSTRACT

A fastener including a shank extending in a direction along a major axis; and a head comprising a hexalobular recess, wherein the hexalobular recess has an inner lobe surface having a radius satisfying

0.234A≤Rᵢ≤2.165A,

wherein A is an outer diameter of the hexalobular recess, and Rᵢ is the radius of the inner lobe surface.

### CROSS-REFERENCE TO RELATED APPLICATIONS

This application claims the benefit of U.S. Provisional Application No. 62/972,734, filed Feb. 13, 2020, the disclosure of which is incorporated herein by reference in its entirety.

### BACKGROUND

Disclosed is a fastener having improved wobble control, reduced stripping, a fastening system including the same, and a method of forming the same.

Fasteners are manufactured with a variety of different recess shapes, such as, for example, slotted or cruciform. A tool, e.g., a bit or driver-bit, can be used to insert and remove a fastener. An end of the tool may have a shape configured for insertion into a head of a fastener to facilitate turning of the fastener for insertion or removal.

Recess shapes have benefits that may be favorable for different applications, or favored in different regions of the world. For example, in the United States consumer market a fastener having a hexalobular recess shape is widely available. The hexalobular recess may allow greater torque to be applied to the recess through a mating hexalobular tool, without stripping the hexalobular recess. Nonetheless, there remains a need for a recess shape, and a corresponding tool, with improved performance.

### SUMMARY

Disclosed is a fastener including: a shank extending in a direction along a major axis; and a head including a hexalobular recess, wherein the hexalobular recess has an inner lobe surface having a radius satisfying

0.234A≤Rᵢ≤2.165A,

wherein A is an outer diameter of the hexalobular recess, and Rᵢ is the radius of the inner lobe surface.

In addition to one or more of the features described above, or as an alternative, the outer diameter of the hexalobular recess A may be 1.695 millimeters to 22.245 millimeters.

The outer diameter of the hexalobular recess A may be 3.88 millimeters to 6.69 millimeters.

The outer diameter of the hexalobular recess A may be 5.543 millimeters to 5.557 millimeters.

The radius of the inner lobe surface Rᵢ may be 1.3 millimeters to 12 millimeters.

The outer diameter of the hexalobular recess A and may satisfy the inequality 0.3A≤Rᵢ≤2A.

The outer diameter of the hexalobular recess A and may satisfy the inequality 0.5A≤Rᵢ≤1.8A.

The hexalobular recess may include a plurality of inner lobe surfaces satisfying the inequality 0.234A≤Rᵢ≤2.165A.

The head may further include a second recess adjacent the hexalobular recess.

The second recess may include a rectilinear shape.

The second recess may be a square recess, and the square recess may be between the shank and the hexalobular recess.

The hexalobular recess may have a depth D₁, the second recess may have a depth D₂, and the first distance D₁ and the second distance D₂ may satisfy the inequality

0.1D₁≤D₂≤10D₁.

The first distance D₁ and second distance D₂ may satisfy the inequality

4 millimeters≤(D₁+D₂)≤5 millimeters.

Also disclosed is a method of forming the fastener, the method including providing a fastener blank; and shaping the fastener blank to provide the fastener having the head and the shank.

Also disclosed is a fastener including: a shank extending in a direction along a major axis; and a head including a hexalobular recess, wherein the hexalobular recess has an inner diameter satisfying the inequality

0.72A≤B≤0.85A,

wherein A is an outer diameter of the hexalobular recess, and wherein B is the inner diameter and is centered on the major axis and extends to an inner lobe surface of the hexalobular recess.

In addition to one or more of the features described above, or as an alternative, the outer diameter of the hexalobular recess A may be 1.695 millimeters to 22.245 millimeters.

The outer diameter of the hexalobular recess A may be 5.543 millimeters to 5.557 millimeters.

The hexalobular recess may have an inner lobe surface having a radius of 1.3 millimeters to 12 millimeters.

The hexalobular recess may have a first inner diameter and a second inner diameter, the first inner diameter may extend to a first inner lobe surface of the hexalobular recess and the second inner diameter may extend to a second inner lobe surface of the hexalobular recess, and the first inner diameter and the second inner diameter may be different.

The head may further include a second recess adjacent the hexalobular recess.

The second recess may include a rectilinear shape.

The second recess may be a square recess, and the square recess may be between the shank and the hexalobular recess.

Also disclosed is a method of forming the fastener, the method including providing a fastener blank; and shaping the fastener blank to provide the fastener having the head and the shank.

Also disclosed is a fastening system including: a fastener including a shank extending in a direction along a major axis, and a head including a hexalobular recess, wherein the hexalobular recess has an inner lobe surface having a radius satisfying

0.234A≤Rᵢ≤2.165A,

wherein A is an outer diameter of the hexalobular recess, and Rᵢ is the radius of the inner lobe surface; and a tool having a shape configured to engage with the head of the fastener.

In addition to one or more of the features described above, or as an alternative, the outer diameter of the hexalobular recess A may be 5.543 millimeters to 5.557 millimeters.

The radius of the inner lobe surface Rᵢ may be 1.3 millimeters to 12 millimeters.

The head may further include a rectilinear recess adjacent the hexalobular recess; the shape of the tool may be configured to engage with the hexalobular recess, configured to engage with the rectilinear recess, or configured to engage with both the hexalobular recess and the rectilinear recess; and an inner diameter of the hexalobular recess may be configured to allow the tool to be inserted into at least 90% of a total depth of the hexalobular recess and the rectilinear recess, the depth being measured along the major axis of the fastener.

### BRIEF DESCRIPTION OF THE DRAWINGS

The following descriptions should not be considered limiting in any way. With reference to the accompanying drawings, in which like elements are numbered alike:

FIG. 1 illustrates dimensions of a hexalobular recess;

FIG. 2 illustrates an enlarged plan view of an embodiment of a hexalobular recess;

FIG. 3 illustrates an embodiment of a fastening system including a fastener and a tool for driving the fastener;

FIG. 4 illustrates an embodiment of a fastener;

FIG. 5 illustrates an enlarged cross-sectional view of a head of the fastener of FIG. 4 having a flat head, in accordance with an embodiment of the disclosure; and

FIG. 6 illustrates an isometric view of an embodiment of a tool for driving a fastener.

### DETAILED DESCRIPTION

A fastener, e.g., a threaded fastener, having a stacked compound recess can reduce or avoid stripping of the recess of the fastener when torque is applied to the recess by a tool. The tool is also referred to as a bit, mating bit, driver, or driver-bit. For example, a fastener having a stacked compound recess may include an upper first recess having a first shape, e.g., hexalobular recess, and a lower second recess between the first recess and a shank of the fastener having a second shape, e.g., a rectilinear shape or a square shape such a Robertson square shape. The second recess may be located adjacent the first recess.

A rectilinear recess (e.g., a Robertson Square recess) may offer improved stiction for a mating tool, e.g., a tool having a shape configured to engage the rectilinear recess. The tool having a shape configured to engage the rectilinear recess can be used to rotatably drive, e.g., insert or remove, the fastener including the first upper recess having a hexalobular shape and the lower second recess having the rectilinear shape. However, when the tool having the shape configured to engage the rectilinear recess is inserted into a recess having a compound recess comprising an upper hexalobular recess and a lower second recess having a square shape, undesirable wobble may result when the tool is used to drive the fastener. Wobble refers to an amount of off-axis movement a tool inserted into the recess may move before the tool contacts the recess to resist such movement.

While not wanting to be bound by theory, it has been surprisingly discovered that a side surface of the tool may interfere with a lobe of the hexalobular recess. The inventor has discovered that interference of the tool with a lobe of the hexalobular recess of the fastener can prevent the tool from suitably engaging the fastener, resulting in undesirable wobble. The undesirable wobble can result in cam-out or stripping of the fastener recess, for example. A configuration which provides improved fit and contact between the tool and fastener having the upper hexalobular recess and a lower rectilinear recess has been developed. The improved configuration results in unexpectedly improved stability when driving the fastener.

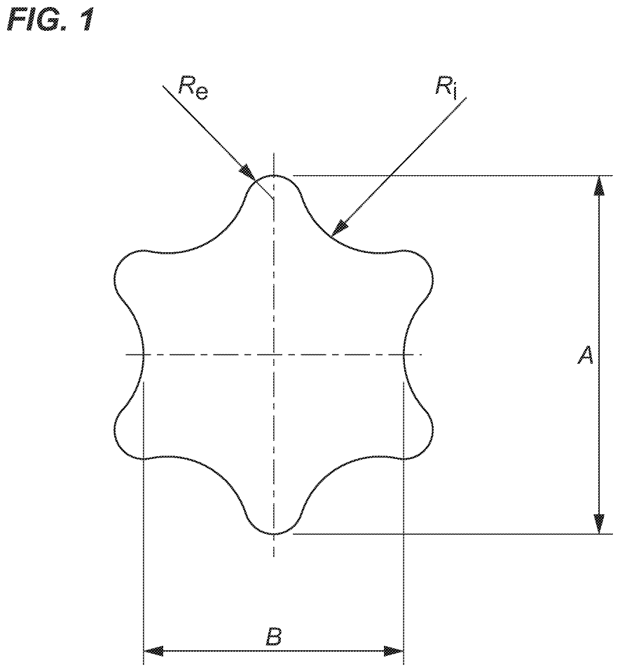

ISO10664:2005(E) the content of which is included herein by reference in its entirety, specifies the shape and dimensions of a hexalobular recess, for bolts and screws, including the curvature of the contour of the internal surface of the hexalobular recess. FIG. 1 illustrates dimensions specified in ISO 10664:2005(E) and Table 1 provides the limiting sizes (in millimeters, mm) of gauge dimensions as specified in ISO10664:2005(E). In FIG. 1, Rᵢ is the inner lobe surface radius, A is the outer diameter of the hexalobular recess, and B is the outer diameter of the hexalobular recess.

TABLE 1

| Socket | A | | B | | Rᵢ | | Rₑ | |
|---|---|---|---|---|---|---|---|---|
| No. | min. | max. | min. | max. | min. | max. | min. | max. |
| 6 | 1.695 | 1.709 | 1.210 | 1.224 | 0.371 | 0.396 | 0.130 | 0.134 |
| 8 | 2.335 | 2.349 | 1.672 | 1.686 | 0.498 | 0.523 | 0.188 | 0.193 |
| 10 | 2.761 | 2.776 | 1.979 | 1.993 | 0.685 | 0.609 | 0.227 | 0.231 |
| 15 | 3.295 | 3.309 | 2.353 | 2.367 | 0.704 | 0.728 | 0.265 | 0.269 |
| 20 | 3.879 | 3.893 | 2.764 | 2.778 | 0.846 | 0.871 | 0.303 | 0.307 |
| 25 | 4.451 | 4.465 | 3.170 | 3.185 | 0.907 | 0.932 | 0.371 | 0.378 |
| 30 | 5.543 | 8.557 | 3.958 | 3.972 | 1.182 | 1.208 | 0.448 | 0.454 |
| 40 | 6.673 | 8.887 | 4.766 | 4.780 | 1.415 | 1.440 | 0.544 | 0.548 |
| 45 | 7.841 | 7.856 | 5.555 | 5.670 | 1.784 | 1.808 | 0.572 | 0.576 |
| 50 | 8.857 | 8.872 | 6.388 | 6.380 | 1.804 | 1.828 | 0.773 | 0.777 |
| 55 | 11.245 | 11.259 | 7.930 | 7.945 | 2.657 | 2.882 | 0.785 | 0.769 |
| 60 | 13.302 | 13.317 | 9.490 | 9.504 | 2.871 | 2.895 | 1.085 | 1.069 |
| 70 | 15.588 | 15.803 | 11.085 | 11.099 | 3.465 | 3.489 | 1.192 | 1.196 |
| 80 | 17.619 | 17.635 | 12.648 | 12.661 | 3.625 | 3.629 | 1.524 | 1.529 |
| 90 | 20.021 | 20.035 | 14.232 | 14.246 | 4.458 | 4.480 | 1.527 | 1.534 |
| 100 | 22.231 | 22.245 | 15.820 | 15.834 | 4.913 | 4.937 | 1.718 | 1.724 |

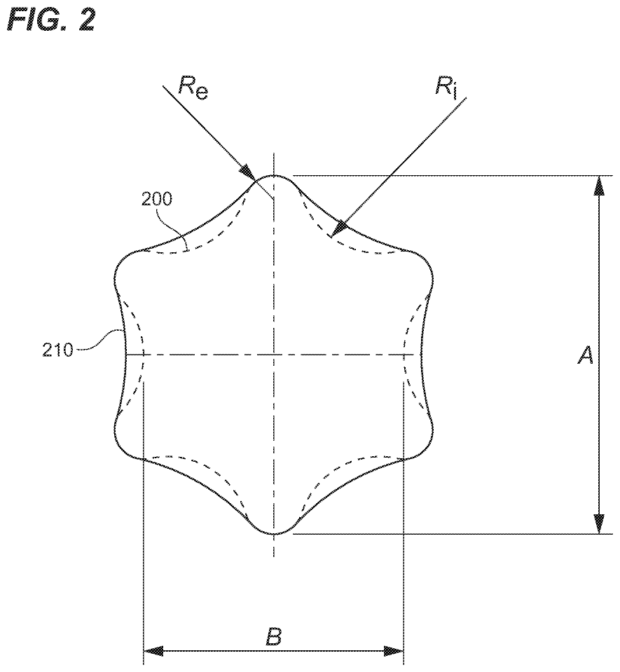

FIG. 2 illustrates an enlarged plan view of a hexalobular recess 210 as disclosed herein, and a hexalobular recess 200 in accordance with ISO 10664:2005(E). As shown in FIG. 2, for a given outer diameter A, the inner diameter B and the radius of the inner lobe surface Rᵢ of the hexalobular recess 200 and the hexalobular recess 210 are different. As shown in FIG. 2, hexalobular recess 210 has inner lobe surface radius Rᵢ which is larger than that specified in ISO 10664:2005(E). Also, the hexalobular recess 210 has an inner diameter B which is larger than that specified in ISO 10664:2005(E). The inner lobe surface of the hexalobular recess 210 may be formed as or defined by an arc as shown in FIG. 2. The arc can be curve or a segmented arc including a plurality of straight segments or lines, e.g., straight lines. Accordingly, the inner lobe surface radius Rᵢ of the hexalobular recess 210 may be defined by a radius Rᵢ of the segmented arc.

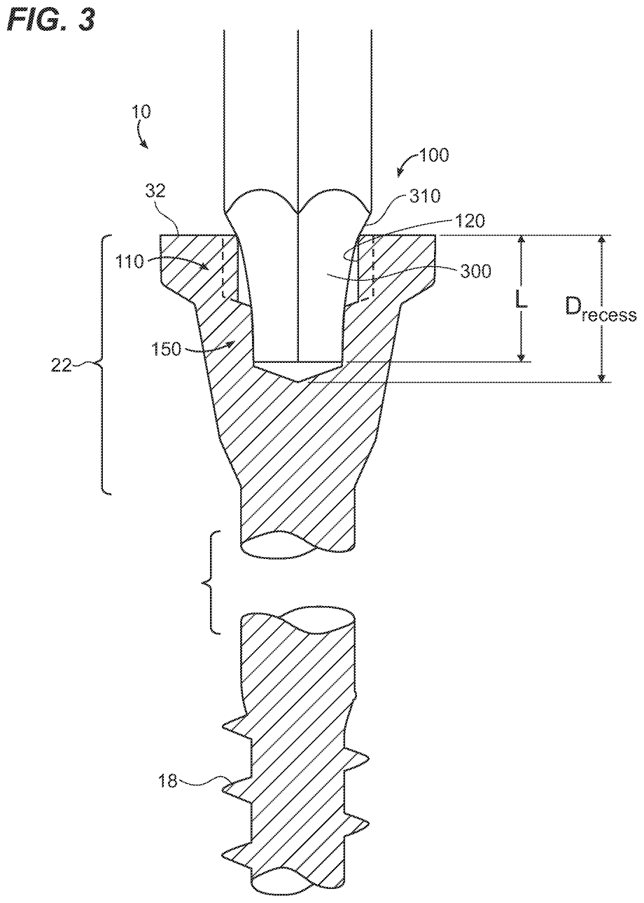

It has been surprisingly found that forming a hexalobular recess with an inner lobe surface radius that is larger than that specified in ISO 10664:2005(E) increases the area, e.g., in plan view, of the hexalobular recess and, with reference to FIG. 3, allows a tool 300 with a tapered side 310 to be inserted into a first recess 110 and a second recess 150 of a stacked compound recess 100 of a fastener 10 to a desirable depth. While not wanting to be bound by theory, it is understood that use of the first hexalobular recess having the disclosed Rᵢ or B dimension allows the tool 300 with a tapered side 310 to be inserted into the first recess 110 and the second recess 150 to a desirable depth, allows use of an increased level of torque to be applied by the tool 300, and provides for reduced wobble. For example, for a fastener having a hexalobular recess as specified by ISO 10664:2005(E), a tapered side 310 of the tool 300 may contact a side wall 120 of the first recess at a top surface 32 of a head 22 of the fastener 10, and may limit the extent to which the square tool 300 can insert into the first recess 110, the second recess 150, or the first recess 110 and the second recess 150. Limited insertion of the tool 300 results in undesirable wobble, and reduces the level of torque that can be applied by the tool 300 to drive the fastener 10. Extending from a lower end of the head 22 of the fastener 10 is a shank that includes a thread 18 helically wrapped around the shank

The second recess 150 may include a rectilinear shape having a length of 2.82 millimeters to 2.86 millimeters. The radius of the inner lobe surface Rᵢ may be configured to allow 2.2 millimeters to 4.1 millimeters of the tool 300 to be inserted into the first recess 110 and the second recess 150. The radius of the inner lobe surface may be configured to allow 2.2 millimeters to 4.1 millimeters of the tool 300 to be inserted into the second recess 150.

The radius of the inner lobe surface Rᵢ of the disclosed hexalobular recess is configured to allow a tool having a rectilinear or square shape to be inserted into the disclosed hexalobular recess a greater distance than that provided by a hexalobular recess having an inner lobe surface radius Rᵢ consistent with ISO 10664:2005(E). As shown in FIG. 2, use of an inner lobe surface radius larger than that consistent with ISO 10664:2005(E) results in an inner diameter that is greater than an inner diameter as specified in ISO 10664:2005(E), permitting the tool to extend farther into the recess by avoiding contact between a side of the tool and the top surface 32 of the fastener 10.

In an aspect, the tool may access at least 90% of a total recess depth of the fastener 10. With further reference to FIG. 3, a length L of the tool inserted into the recess may be at least 90%, for example, 90 to 99.9%, 92 to 99.9%, 94 to 99.5%, 96 to 99.5%, or 98 to 99%, of the total recess depth D_{recess} of the fastener. In an aspect, the tool has a shape configured to engage with the second recess, e.g., has a rectilinear or square shape. For a fastener having a first hexalobular recess, and a second square recess, use of a hexalobular shape having a larger inner lobe surface radius Rᵢ avoids interference between the tool and the hexalobular recess, permitting improved engagement of tool and the recess. Alternatively, use of a hexalobular shape having a larger inner diameter B, e.g., 0.72A≤B≤0.85A, avoids interference between the tool and the hexalobular recess, permitting improved engagement of tool and the recess. The improved engagement may minimize or eliminate wobble, and reduce stripping during driving of the fastener.

The square tool 300 can be inserted into the first recess 110 and the second recess 150 to an extent such that the square tool 300 contacts a bottom 180 of the second recess 150. While not wanting to be bound by theory, it is understood that the square tool 300 contacting a bottom 180 of the second recess 150 may minimize or eliminate wobble when driving of the fastener 10, and allow for an increased level of torque to be applied by the square tool 300. A tapered side 310 of a square tool 300 can engage with the inner lobe surface. An inner lobe surface radius that is larger than that specified in ISO 10664:2005(E) may allow a square tool 300 with a tapered side 310 to be inserted into the first recess 110 and the second recess 150 to a desirable depth, and a relatively increased level of torque can be applied by the square tool 300.

A head of a fastener may include a hexalobular recess having an inner lobe surface having a radius satisfying the inequality

0.234A≤Rᵢ≤2.165A,

wherein A is an outer diameter of the hexalobular recess and Rᵢ is the radius of the inner lobe surface.

The outer diameter of the hexalobular recess A may be, for example, 1.695 millimeters to 22.245 millimeters, e.g., corresponding to a T₆, T₈, T₁₀, T₁₅, T₂₀, T₂₅, T₃₀, T₄₀, T₄₅, T₅₀, T₅₅, T₆₀, T₇₀, T₈₀, T₉₀, or T₁₀₀ hexalobular recess; 3.88 millimeters to 6.69 millimeters, e.g., corresponding to a T₂₀, T₂₅, T₃₀, or T₄₀ hexalobular recess; or 5.543 millimeters to 5.557 millimeters, e.g., corresponding to a T₃₀ hexalobular recess. The outer diameter of the hexalobular recess A and the radius of the inner lobe surface Rᵢ may, for example, satisfy the inequality 0.3A≤Rᵢ≤2A or 0.5A≤Rᵢ≤1.8A. In contrast, for a T₃₀ hexalobular recess, ISO 10664:2005(E) provides for a hexalobular recess that has an inner lobe surface having an inner lobe surface radius Rᵢ satisfying the inequality

0.213A≤Rᵢ≤0.218A.

With further reference, for example, to a T₃₀ hexalobular recess, the radius of the inner lobe surface Rᵢ may be 1.3 millimeters to 12.0 millimeters. In contrast, for a T₃₀ hexalobular recess, ISO 10664:2005(E) provides for a hexalobular recess that has an inner lobe surface having an inner lobe surface radius Rᵢ satisfying the inequality

1.182 millimeters≤Rᵢ≤1.206 millimeters.

According to an embodiment, a head of a fastener may include a hexalobular recess having an inner diameter B satisfying the inequality

0.72A≤B≤0.85A,

wherein A is an outer diameter of the hexalobular recess, and B is the inner diameter and is centered on the major axis and extends to an inner lobe surface of the hexalobular recess, as shown in FIG. 1 and FIG. 2. In contrast, for a T₃₀ hexalobular recess, ISO 10664:2005(E) provides for a hexalobular recess that has an inner diameter B satisfying the inequality

0.712A≤B≤0.717A.

The hexalobular recess may have a first inner diameter and a second inner diameter, the first inner diameter may extend to a first inner lobe surface of the hexalobular recess and the second inner diameter may extend to a second inner lobe surface of the hexalobular recess, and the first inner diameter and the second inner diameter may be different, e.g., a hexalobular recess having different concave surfaces to provide a non-symmetrical hexalobular recess.

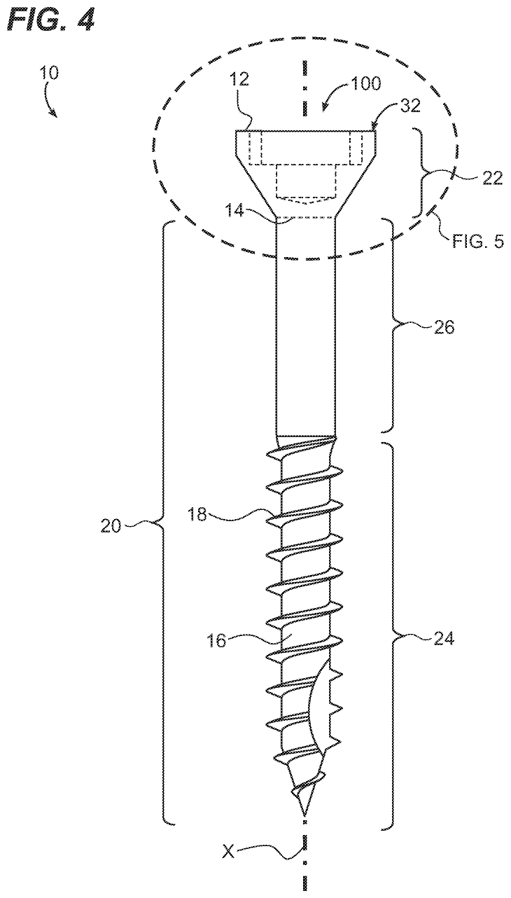

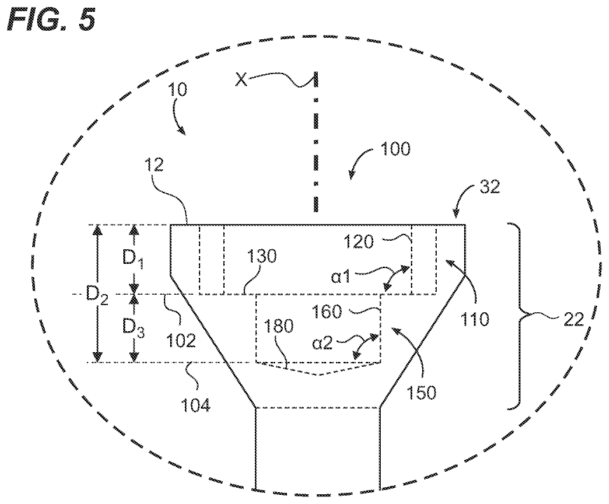

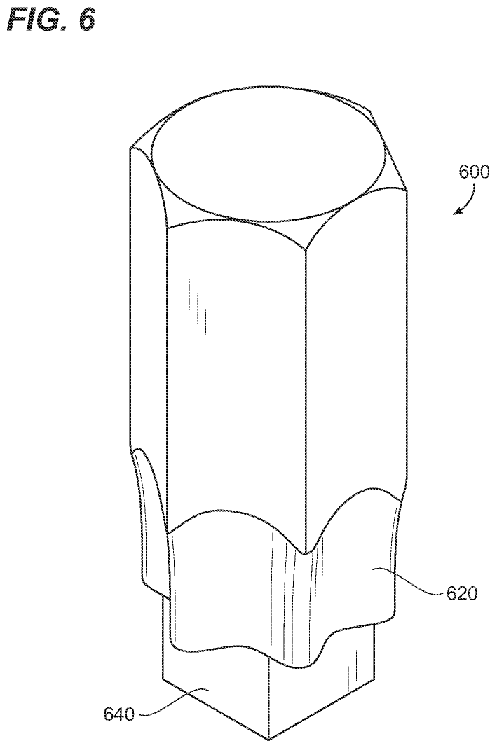

Further description of the disclosed fastener and tool are presented herein by way of exemplification and not limitation with reference to FIG. 4, FIG. 5, and FIG. 6.

FIG. 4 schematically illustrates a fastener 10 having a stacked compound recess 100. The fastener 10 includes shank 20 and a head 22. A head 22 head includes an upper end 12 and a lower end 14 opposite the upper end 12. The shank 20 extends from the lower end 14 of the head 22. The shank 20 may be attached to the head 22 at the lower end 14 of the head 22 or formed with the head 22 at the lower end 14 of the head 22. The shank 20 includes a threaded portion 24. The threaded portion 24 includes a thread 18 helically wrapped around a shaft 16 of the shank 20. The thread 18 may be wrapped around the shaft 16 such that the fastener 10 may be right-handed or left-handed. There may be a non-threaded portion 26 interposed between the threaded portion 24 and the lower end 14 of the head 22 of the fastener 10, as shown in FIG. 4.

A top surface 32 of the head 22 of the fastener 10 may be flat, as illustrated in FIG. 4. While a flat head is utilized for illustration, the fastener may have other head types such as, for example, a head having an oval, button, round, truss, cheese (e.g., having a disc with a cylindrical outer edge, height approximately half the head diameter, and a flat bearing surface), fillister, pan washer, cylinder, hexagon, indented hexagon, washer, or pan configuration.

FIG. 5 illustrates an enlarged cross-sectional view of the fastener 10 shown in FIG. 4 having a top surface 32 that is flat. The head 22 includes a top surface 32 located at the upper end 12 of the head 22. The top surface 32 may be a substantially flat surface oriented about perpendicular with a major axis X of the fastener 10 having the stacked compound recess 100. The head 22 of the fastener 10 includes the stacked compound recess 100 formed on the top surface 32. The stacked compound recess 100 is formed in the top surface 32 of the head 22 and extends into the head 22.

Referring now to FIG. 5, with continued reference to FIG. 4, the stacked compound recess 100 includes a first recess 110 having a first shape and a second recess 150 having a second shape. The first recess 110 may be configured to be driven (e.g., drivable by a tool) and the second recess 150 is configured to be driven, such that the first recess 110 and the second recess 150 may be driven independently and/or in combination using a tool having a shape that mates to the first recess 110 and/or the second recess 150. For example, the tool may have a shape configured to engage with the first recess 110, the tool may have a shape configured to engage with the second recess 150, or the tool may have a shape configured to engage with the first recess 110 and the second recess 150. The tool may have a shape including a surface configured to engage with an opposing surface of the first recess 110, the tool may have a shape including a surface configured to engage with an opposing surface of the second recess 150, or the tool may have a shape including a surface configured to engage with an opposing surface of the first recess 110 and the second recess 150. The second recess may have a shape that is different than (e.g., non-equivalent to) a shape of the first recess.

The first recess shape may be hexalobular, and the second recess shape may be rectilinear, e.g., a square. The shape of the first recess 110 may be lobed, e.g., hexalobular. The shape of the second recess 150 may be rectilinear (e.g., a Robertson recess). Advantageously, a fastener 10 having a first recess 110 and a second recess of different shapes may be driven by different tools, e.g., a tool having a shape corresponding to the first recess shape, a tool having a shape corresponding to the second recess shape, or a tool having a shape corresponding to a combination of the first recess shape and the second recess shape.

The first recess 110 and the second recess 150 may be located on different planes 102, 104 of the stacked compound recess 100 relative to a major axis X of the fastener 10 having a stacked compound recess 100, as shown in FIG. 5. Advantageously, the first recess 110 and the second recess 150 being located on different planes 102, 104 may allow one recess to be driven independently of the other recess.

FIG. 5 illustrates a fastener 10 having a top surface 32 that is flat. As shown in FIG. 5, the first recess 110 is located on a first plane 102 of the stacked compound recess 100. The first plane 102 is located at a first distance D₁ away from the top surface 32 as measured linearly along the major axis X of the fastener 10 having a stacked compound recess 100. The first recess 110 has a depth equivalent to the first distance D₁. The first plane 102 may be oriented perpendicular to the major axis X of the fastener 10. As shown in FIG. 5, the second recess 150 is located on a second plane 104 of the stacked compound recess 100. The second plane 104 may be oriented perpendicular to the major axis X of the fastener 10. The second plane 104 may be oriented parallel to the first plane 102. The second plane 104 is located at a second distance D₂ away from the top surface 32 as measured linearly along the major axis X of the fastener 10 having a stacked compound recess 100. The second recess 150 has a depth of a third distance D₃, which is equivalent to the second distance D₂ minus the first distance D₁. A ratio of the first distance D₁ to third distance D₃ (i.e., D₁/D₃) may be between 1:10 to 10:1, 2:8 to 8:2, 3:7 to 7:3, or 4:6 to 6:4. The ratio of the first distance D₁ to third distance D₃ (i.e., D₁/D₃) may be equal to 1. A ratio of the third distance D₃ to the first distance D₁ (i.e., D₃/D₁) may be between 1:10 to 10:1, 2:8 to 8:2, 3:7 to 7:3, or 4:6 to 6:4. The ratio of the third distance D₃ to the first distance D₁ (i.e., D₃/D₁) may be equal to 1. The first distance D₁ and the second distance D₂ may satisfy the inequality 4 millimeters≤D₁+D₂≤5 millimeters. The depth of the second recess 150 may be about equal to the depth of the first recess 110, and the third distance D₃ may be about equal to the first distance D₁. Further advantageously, the depth (i.e., distance D₁) of the first recess 110 may be about equal to the depth (i.e., distance D₃) of the second recess 150, one recess may not become engaged prior to the other recess, and the first recess 110 and the second recess 150 may be simultaneous engaged when being driven by a tool that mates with both the first recess 110 and the second recess 150. The disclosed configuration solves what is known as a 6/4 problem resulting from the combination of a hexalobular recess and a four-sided recess.

The first recess 110 initiates at a top surface 32 of the head 22 and extends into the head 22 to a bottom 130 of the first recess 110. The second recess may initiate at the bottom 130 of the first recess 110 and extend into the head 22 to a bottom 180 of the second recess 150, as shown in FIG. 5.

The side wall 120 of the first recess 110 may be about parallel relative to the major axis X of the fastener 10, as shown in FIG. 5. The side wall 120 of the first recess 110 may be non-parallel relative to the major axis X of the fastener 10. The side wall 120 of the first recess 110 may be oriented at first angle α1 such that the side wall 120 is non-perpendicular relative to the bottom 130 of the first recess 110. The first angle α1 may be greater than or equal to 60° and less than or equal to 90°. The first angle α1 may be 90°.

The second recess 150 includes a side wall 160 extending from the bottom 130 of the first recess 110 to the second plane 104. The side wall 160 of the second recess 150 may form the shape of the second recess 150. The side wall 160 of the second recess 150 may be about parallel relative to the major axis X of the fastener 10, as shown in FIG. 5. The side wall 160 of the second recess 150 may be non-parallel relative to the major axis X of the fastener 10. Advantageously, orienting the side wall 120 of the first recess 110 or the side wall 160 of the second recess 150 at a non-parallel angle relative to the major axis X of the fastener 10 may produce a non-magnetic stick fit on a tool that mates with both the first recess 110 and the second recess 150.

The side wall 160 of the second recess 150 may be oriented at second angle α2 such that the side wall 160 is non-perpendicular relative to the bottom 180 of the second recess 150. The side wall 160 of the second recess 150 may be oriented at second angle α2 that not equivalent to the first angle α1. Advantageously, the second angle α2 being different from the first angle α1 may produce a non-magnetic stick fit on a tool that mates with both the first recess 110 and the second recess 150. The second angle α2 may be between 80° to 90°; 82° to 99°; or 94° to 98°. The second angle α2 may be between 98° to 98.5°. The second angle α2 may be 90°.

The shape of the first recess 110 of a stacked compound recess 100 in the top surface 32 of the head 22 of the fastener 10 may be hexalobular and the shape of the second recess 150 may be rectilinear. The first recess shape may be formed by side wall 120. The first recess shape may be formed by one curved side wall 120 and the second recess shape may be formed by four side walls 160.

The second recess shape may be oriented relative to the first recess shape such that features of the second recess shape are positioned relative to features of the first recess shape in a certain manner. For example, a rectilinear second recess 150 may include opposing first and second sides and opposing third and fourth sides, which are perpendicular to the first and second sides of the second recess 150. A hexalobular first recess 100 may include opposing first and second lobes, opposing third and fourth lobes, and opposing fifth and sixth lobes. The third and fifth lobes may be adjacent to one another and the fourth and sixth lobes may be adjacent to one another. The second recess shape may be oriented relative to the first recess shape such that the first side of the second recess 150 may be adjacent the first lobe of the first recess 100 and the second side of the second recess 150 may be adjacent the second lobe of the first recess 100. The third side of the second recess 150 may be adjacent an area between the third and fifth lobes and the fourth side of the second recess 150 may be adjacent an area between the fourth and sixth lobes.

FIG. 6 illustrates a tool 600 for use with the disclosed fastener. The tool 600 may have a shape configured to engage with the first recess 110 and the second recess 150, as shown, for example, in FIG. 3 and FIG. 5. The tool 600 may have a shape including a surface configured to engage with opposing surfaces of the first recess 110 and the second recess 150, as shown, for example, in FIG. 3 and FIG. 5. The tool may have a hexalobular upper shape 620 and a rectilinear lower shape 640.

A fastening system may include a fastener, which includes a first recess and a second recess adjacent the first recess. The first recess may include a hexalobular shape. The fastening system may also include a tool having a shape configured to engage with the first recess, configured to engage with the second recess, or configured to engage with the first recess and the second recess. The tool may include a hexalobular shape configured to engage with the first recess and a rectilinear shape configured to engage with the second recess.

According to an embodiment, a method of forming the fastener may include providing a fastener blank; and shaping the fastener blank to provide the fastener having the head and the shank. For example, the method may include driving a punch into a head of the fastener to form the fastener including the hexalobular recess in the head of the fastener to form the fastener.

A punch for forming a first recess and a second recess in a fastener may have a recess forming head including a first punch-tier and a second punch-tier for forming the first recess and the second recess, respectively. A cold-forming process to form a fastener including two recesses may include driving a punch into a blank head of a fastener. The material, e.g., metal, of the head of the fastener may become temporarily liquid under the extreme pressure and impact of the punch, and may flow around the shape of the punch. The recesses so-formed may adopt the shape and dimensions of the punch. The shape and dimensions of the punch may mirror the dimensions of the recesses formed. Thereafter, the punch may be removed from the head of the fastener, forming a fastener including a first recess and a second recess.

Aspects

In an aspect, disclosed is a fastener comprising: a shank extending in a direction along a major axis; and a head comprising a hexalobular recess, wherein the hexalobular recess has an inner lobe surface having a radius satisfying 0.234A≤Rᵢ≤2.165A, wherein A is an outer diameter of the hexalobular recess, and Rᵢ is the radius of the inner lobe surface.

In an aspect, disclosed is a fastener comprising: a shank extending in a direction along a major axis; and a head comprising a hexalobular recess, wherein the hexalobular recess has an inner diameter satisfying 0.72A≤B≤0.85A, wherein A is an outer diameter of the hexalobular recess, and wherein B is the inner diameter and is centered on the major axis and extends to an inner lobe surface of the hexalobular recess.

In an aspect, disclosed is a fastening system comprising: a fastener comprising a shank extending in a direction along a major axis, and a head comprising a hexalobular recess, wherein the hexalobular recess has an inner lobe surface having a radius satisfying 0.234A≤Rᵢ≤2.165A, wherein A is an outer diameter of the hexalobular recess, and Rᵢ is the radius of the inner lobe surface; and a tool having a shape configured to engage with the head of the fastener.

In any of the various aspects, A may be 1.695 millimeters to 22.245 millimeters; and/or A may be 3.88 millimeters to 6.69 millimeters; and/or A may be 5.543 millimeters to 5.557 millimeters; and/or Rᵢ may satisfy 0.3A≤Rᵢ≤2A; and/or Rᵢ may satisfy 0.5A≤Rᵢ≤1.8A; and/or the hexalobular recess may comprise a plurality of inner lobe surfaces satisfying 0.234A≤Rᵢ≤2.165A; and/or Rᵢ may be 1.3 millimeters to 12 millimeters; and/or the head may further comprise a second recess adjacent the hexalobular recess; and/or the second recess may comprise a rectilinear shape; and/or the second recess may be a square recess, and the square recess may be between the shank and the hexalobular recess; and/or the hexalobular recess may have a depth of D₁, the second recess may have a depth of D₂, and D₁ and D₂ may satisfy 0.1D₁≤D₂≤10D₁; and/or D₁ and D₂ may satisfy 4 millimeters≤(D₁+D₂)≤5 millimeters; and/or a method of forming the fastener may comprise providing a fastener blank; and shaping the fastener blank to provide the fastener having the head and the shank; and/or the hexalobular recess may have a first inner diameter and a second inner diameter, the first inner diameter may extend to a first inner lobe surface of the hexalobular recess and the second inner diameter may extend to a second inner lobe surface of the hexalobular recess, and the first inner diameter and the second inner diameter may be different; and/or the head may further comprise a rectilinear recess adjacent the hexalobular recess; the shape of the tool may be configured to engage with the hexalobular recess, configured to engage with the rectilinear recess, or configured to engage with both the hexalobular recess and the rectilinear recess; and an inner diameter of the hexalobular recess may be configured to allow the tool to be inserted into at least 90% of a total depth of the hexalobular recess and the rectilinear recess, the depth being measured along the major axis of the fastener.

The invention has been described with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fastener comprising:
a shank extending in a direction along a major axis; and
a head comprising a hexalobular recess,
wherein the hexalobular recess has an inner lobe surface having a radius satisfying
0.234A≤Rᵢ≤2.165A,
wherein
A is an outer diameter of the hexalobular recess, and
Rᵢ is the radius of the inner lobe surface.

2. The fastener of claim 1, wherein A is 1.695 millimeters to 22.245 millimeters.

3. The fastener of claim 2, wherein A is 3.88 millimeters to 6.69 millimeters.

4. The fastener of claim 3, wherein A is 5.543 millimeters to 5.557 millimeters.

5. The fastener of claim 1, wherein 0.3A≤Rᵢ≤2A.

6. The fastener of claim 5, wherein 0.5A≤Rᵢ≤1.8A.

7. The fastener of claim 1, wherein the hexalobular recess comprises a plurality of inner lobe surfaces satisfying 0.234A≤Rᵢ≤2.165A.

8. The fastener of claim 1, wherein Rᵢ is 1.3 millimeters to 12 millimeters.

9. The fastener of claim 1, wherein the head further comprises a second recess adjacent the hexalobular recess.

10. The fastener of claim 9, wherein the second recess comprises a rectilinear shape.

11. The fastener of claim 10, wherein the second recess is a square recess, and the square recess is between the shank and the hexalobular recess.

12. The fastener of claim 9, wherein:
the hexalobular recess has a depth of D₁,
the second recess has a depth of D₂, and
wherein D₁ and D₂ satisfy
0.1D₁≤D₂≤10D₁.

13. The fastener of claim 12, wherein 4 millimeters≤(D₁+D₂)≤5 millimeters.

14. A method of forming the fastener of claim 1, the method comprising:
providing a fastener blank; and
shaping the fastener blank to provide the fastener having the head and the shank.

15. A fastener comprising:
a shank extending in a direction along a major axis; and
a head comprising a hexalobular recess,
wherein the hexalobular recess has an inner diameter satisfying
0.72A≤B≤0.85A,
wherein A is an outer diameter of the hexalobular recess, and
wherein B is the inner diameter and is centered on the major axis and extends to an inner lobe surface of the hexalobular recess.

16. The fastener of claim 15, wherein A is 1.695 millimeters to 22.245 millimeters.

17. The fastener of claim 16, wherein A is 5.543 millimeters to 5.557 millimeters.

18. The fastener of claim 15, wherein the hexalobular recess has an inner lobe surface having a radius of 1.3 millimeters to 12 millimeters.

19. The fastener of claim 15,
wherein the hexalobular recess has a first inner diameter and a second inner diameter,
wherein the first inner diameter extends to a first inner lobe surface of the hexalobular recess and the second inner diameter extends to a second inner lobe surface of the hexalobular recess, and
wherein the first inner diameter and the second inner diameter are different.

20. The fastener of claim 15, wherein the head further comprises a second recess adjacent the hexalobular recess.

21. The fastener of claim 20, wherein the second recess comprises a rectilinear shape.

22. The fastener of claim 21, wherein the second recess is a square recess, and the square recess is between the shank and the hexalobular recess.

23. A method of forming the fastener of claim 15, the method comprising:
providing a fastener blank; and
shaping the fastener blank to provide the fastener having the head and the shank.

24. A fastening system comprising:
a fastener comprising
a shank extending in a direction along a major axis, and
a head comprising a hexalobular recess, wherein the hexalobular recess has an inner lobe surface having a radius satisfying
0.234A≤Rᵢ≤2.165A,
wherein
A is an outer diameter of the hexalobular recess, and
Rᵢ is the radius of the inner lobe surface; and
a tool having a shape configured to engage with the head of the fastener.

25. The fastening system of claim 24, wherein A is 5.543 millimeters to 5.557 millimeters.

26. The fastening system of claim 24, wherein Rᵢ is 1.3 millimeters to 12 millimeters.

27. The fastening system of claim 24, wherein
the head further comprises a rectilinear recess adjacent the hexalobular recess;
the shape of the tool is configured to engage with the hexalobular recess, configured to engage with the rectilinear recess, or configured to engage with both the hexalobular recess and the rectilinear recess; and
an inner diameter of the hexalobular recess is configured to allow the tool to be inserted into at least 90% of a total depth of the hexalobular recess and the rectilinear recess, the depth being measured along the major axis of the fastener.
